(19) United States
(12) Patent Application Publication
(10) Pub. No.: US 2001/0039511 A1
(43) Pub. Date: Nov. 8, 2001

(54) Lottery award promotional method and system

(76) Inventors: Noel Duckworth, Wellington (NZ); Chris Berryman, Christchurch (NZ)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/733,614

(22) Filed: Dec. 7, 2000

(30) Foreign Application Priority Data
Dec. 10, 1999 (NZ) 501706

(51) Int. Cl. G06F 17/60

(52) U.S. Cl. 705/14

(57) ABSTRACT

An electronic point of sale and Internet promotional method and system that promotes customer purchases and loyalty at member merchants. The system records customer sales data and, under the control of one or more merchants and a sales promotion computer system, involves generating and storing random numbers at the sales promotion computer system, loading awards records on the promotion system consisting of sales criteria which define customer award entitlements, and comparing customer transaction data received from a sales system with the award records at the promotion computer system to determine if the customer is entitled to an award. If so, one or more of the numbers are printed on a document associated with each transaction. The printed numbers constitute a lottery ticket in a lottery to be drawn on a periodic basis with prizes awarded to ticket holders having a number or numbers which are the same as or are a defined sub-set of the numbers drawn.

### TECHNICAL FIELD

The present invention relates to electronic point of sale and Internet promotional methods and systems. In particular, the present invention is a sales promotion method that promotes customer purchases and loyalty at various member merchants.

### BACKGROUND OF THE INVENTION

Customer purchase promotion and loyalty programs have been developed by the travel industry, an example of such is a “frequent flyer” program. According to such a program, when a traveller books a flight, a certain amount of “mileage points” is calculated and the points are awarded when the traveller takes a flight. When a traveller has accumulated a significant number of mileage points, he may redeem these points for an award specified by the program.

Other purchase promotion and loyalty programs are provided by issuing a coupon corresponding to a sales amount and presenting a customer with an awarding gift when the number of coupons reaches a predetermined value.

In another known system a magnetic card is issued to a customer without a paper coupon, and points are recorded on the magnetic card each time the customer purchases goods. Once the points reach a certain threshold the customer may redeem the points to use as a discount or to receive an award or gift.

All of the abovementioned types of programs have been implemented via the award of goods or services as a reward for purchases or loyalty.

### SUMMARY OF THE INVENTION

It is the object of the present invention to provide an online, electronic, point of sale or Internet promotional method and system which provides customers with lottery type and other awards.

Accordingly in one aspect the invention consists in a method of sales promotion using sales systems, which record customer sales data, under the control of one or more merchants and a sales promotion computer system comprising the steps of:

(a) generating and storing random numbers at said sales promotion computer system;

(b) loading awards records on said promotion system consisting of sales criteria which defines customer award entitlement;

(c) comparing customer transaction data received from a sales system with said award records at said promotion computer system to determine if the customer is entitled to an award, and if so;

(d) printing on a document associated with each transaction one or more of said numbers;

(e) said printed numbers constituting a lottery ticket in a lottery to be drawn on a periodic basis with prizes awarded to ticket holders having a number or numbers which are the same as or are a defined sub-set of the numbers drawn.

In a further aspect the invention consists in a method of sales promotion using point of sale (POS) systems under the control of one or more merchants and a computer system controlled by a promotion facilitator consisting of a host and a plurality of remote controllers each associated with at least one respective POS system, said method comprising the steps of:

(a) generating and storing lines of random numbers at the host computer;

(b) transmitting said lines of numbers from said host to each remote controller;

(c) defining awards records at said host computer using merchant, customer, product, and purchase value data which will entitle customers to awards;

(d) transmitting said awards records from said host computer to appropriate remote controllers;

(e) receiving at each remote controller, customer, product and price data corresponding to the product purchases by each customer at the corresponding POS system.

(f) comparing said customer transaction data with said award records data at said remote controllers to determine if the customer is entitled to an award, and if so;

(g) printing a ticket at said POS system having one or more of said lines of numbers;

(h) said ticket being a lottery ticket in a lottery to be drawn on a periodic basis with prizes awarded to ticket holders having a line of numbers which are the same as or a defined sub-set of the numbers selected in the lottery draw.

In yet another aspect the invention consists in a point of sale (POS) promotion system comprising remote controllers associated and communicating with POS systems under the control of one or more merchants and a host computer controlled by a promotion facilitator, said remote controllers having ticket printers associated therewith, said controllers and computer programmed to:

(a) generate and store lines of random numbers at the host computer;

(b) transmit said lines of numbers from said host to each remote controller;

(c) define awards records at said host computer using merchant, customer, product, and purchase value data which will entitle customers to awards;

(d) transmit said awards records from said host computer to appropriate remote controllers;

(e) receive at each remote controller product, customer, and price data corresponding to the product purchases made by each customer at the associated POS system;

(f) compare said customer transaction data and said award records data to determine if the customer is entitled to an award, and if so;

(g) print at the ticket printer of the appropriate POS system, a ticker having one or more of said lines of numbers;

(h) said ticket being a lottery ticket in a lottery to be drawn on a periodic basis with prizes awarded to ticket holders having a line of numbers which are the same as or a defined sub-set of the numbers selected in the lottery draw.

In yet another aspect the invention consists in a method of sales promotion using sales systems under the control of one or more merchants and a sales promotion system comprising the steps of:

(a) receiving from said sales promotion system lines of numbers at a remote controller.

(b) receiving award records from said sales promotion system to said remote controller.

(c) receiving at each remote controller, customer, product and price data corresponding to the product purchases by each customer at the corresponding POS system of said remote controller,

(d) comparing said customer purchase data with said award records data at said remote controllers to determine if the customer is entitled to said award, and if so;

(e) printing on a document associated with each transaction one or more of said numbers and/or voucher and/or instant prize entitlement;

(f) said printed numbers constituting a lottery ticket in a lottery to be drawn on a periodic basis with prizes awarded to ticket holders having a number or numbers which are the same as or are a defined subset of the numbers drawn.

In yet another aspect the invention consists in a method of sales promotion using sales system under the control of one or more merchants and a sales promotion system comprising the steps of:

(a) generating and storing lines of numbers at the host computer;

(b) transmitting said lines of numbers from said host to said merchant,

(c) defining awards records at said host computer using merchant, customer, product and purchase value data which will entitle customers to awards,

(d) transmitting said awards from the host computer to said one or more merchants, said one or more merchants being able to print on a document one or more said numbers, said document being given to said customer when said customer's purchases correspond to said awards records, said document constituting a lottery ticket and/or voucher and/or instant prize entitlement.

In this specification hereinafter “lottery” is defined as a means of promoting sales and service by issuing numbered tickets and giving prizes to the holders of numbers drawn at random, and includes sweepstakes and prize draws.

### BRIEF DESCRIPTION OF THE DRAWINGS

FIG. 1 is a flow chart showing the major hardware components of the present invention, and

FIG. 2 is a flow chart showing the application architecture of the present invention.

### DETAILED DESCRIPTION OF THE PREFERRED EMBODIMENT

The present invention is a retail promotional system in which shoppers making specified levels and type of purchases at participating merchant outlets are eligible to receive an entry in a lottery at no charge to them. In the preferred embodiment the entry comprises a game ticket containing lines of numbers that may win prizes in various divisions based on a match with numbers drawn at the end of each period. Merchants are charged for each game line issued. Part of this charge is allocated to a prize pool and part to fund game expenses. Instant prizes are also offered to provide immediate customer appeal.

The lottery draw is drawn at predetermined intervals. The more game lines a customer has accumulated during the period the greater their chance of winning. Winning numbers are drawn and a customer will win a prize, for example cash or consumer goods, by preferably matching numbers in any of the available divisions. The prize won in each division will be confirmed and advised preferably within one hour of the lottery draw, and may grow depending on the amount of game lines issued or may be predetermined. Winning numbers may be drawn by either a mechanical drawing device or by other means, including a computer based random number generator. Winning numbers may be entered into the host via manual keyboard entry or via an electronic link.

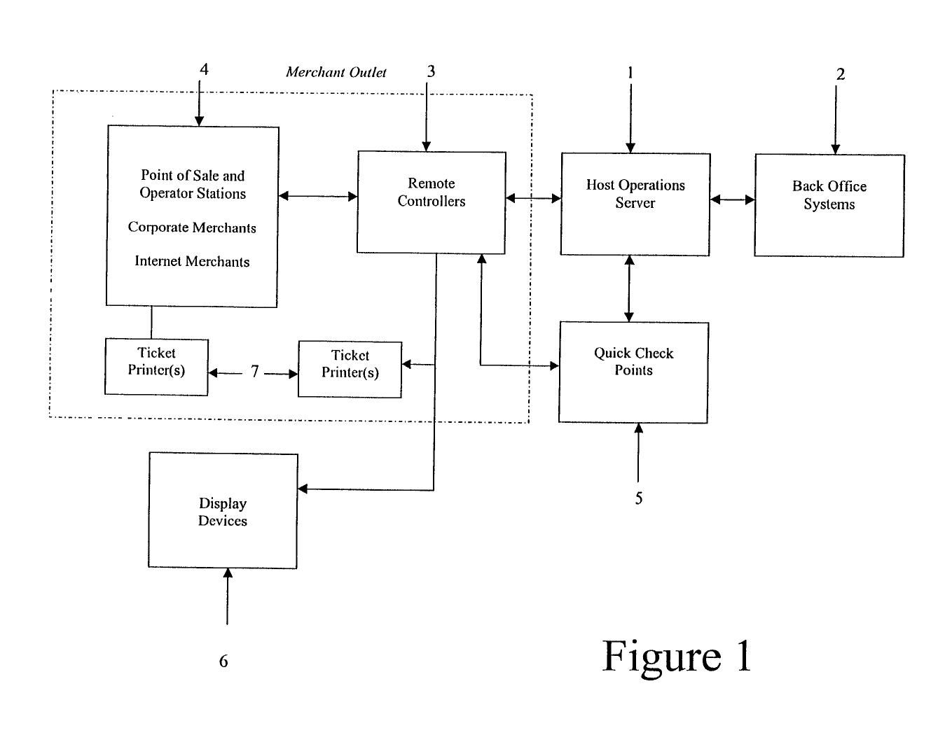

Referring now to FIG. 1, major components of the present invention include a host operations server 1, a back office server 2, remote controllers 3 and operator stations 4. The host operations server 1 and back office server are located centrally at the promotions facilitator's data centre whereas a remote controller 3 and operator stations 4 are preferably located remotely at merchant outlets. Known data communication techniques are used to connect remote controllers 3 to the host server 1 operator stations and POS systems.

When a customer completes their transactions, for example purchases, at participating merchant outlets and becomes eligible to receive an award, such as a game ticket, instant prize or a voucher, (that is, by meeting a minimum amount of spending in dollars or meets other qualification criteria such as purchases a product currently on promotion at the merchant outlet). Once a customer is eligible a ticket with an appropriate amount of game lines and/or instant prize ticket and/or voucher is produced at the merchant station as appropriate. The game lines on the ticket can then be compared to the game lines as drawn. The ticket may also be checked at merchant outlets (through the operator station 4 and local controller 3), via the Internet or by ringing an 0900 number, to determine whether a prize has been won. Also customer accessed stations 5 (“quick check points”) may be provided that comprise a scanner, keypad display and/or card reader, where customers can quickly check whether their tickets have won a prize. These quick check points are preferably located at participating merchant outlets and in busy foot traffic locations such as airports, supermarket foyers, malls and the like.

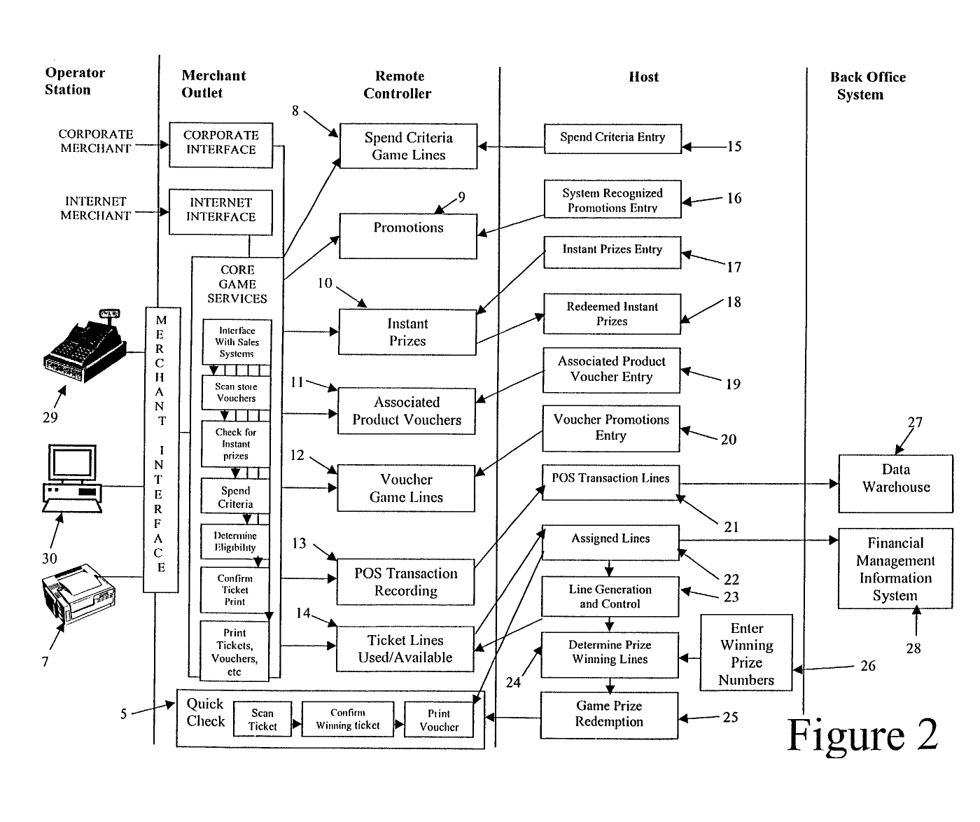

Referring to FIGS. 1 and 2, the host operations server 1, controls overall operation of the present system including generation of lottery lines and other awards, including instant prizes and vouchers, records of tickets issued, customer details, merchant details, promotions details, transaction details, lottery management, prize allocation and prize redemption. Any function that can be accessed from any merchant outlet or quick check point is ultimately controlled from the host operations server 1.

The host 1 will create and download blocks of available game lines as required plus instant prizes for the remote controller 3 to award to customers under standard game rules. Allocated game lines and instant prizes will be fed by the local controller 3 back to the host immediately or on a load smoothing basis. Should the host 1 or the link to it be unavailable, the remote controller will continue to allocate game lines as long as there are locally stored unallocated lines available, with details of allocated lines stored locally for upload when host services are restored.

Host application functions include game line number generation and control, prize pool accumulation and reporting, game and merchant accounting and prize redemption. Also the host controls system administration functions such as promotion items entry and deletion, instant prize creation and allocation criteria, voucher specials, customer data and merchant outlet details.

The back office server 2 backs-up the operations server and fulfils reporting, Internet access to current and historic information, all financial transactions via an FMIS 24 (Financial Management Information System) plus data warehousing functions. The data warehouse 23 has the function of storing customer data that can subsequently be analysed for use in targeted merchandising initiatives.

A remote controller 3 and one or more operator stations 4 is located at merchant outlet. The remote controller 3 controls physical and logical operation of the merchant outlets that interface with customers or billing files and produce tickets. Each remote controller 3 consists of a PC or similar programmable device which will be pre-loaded at intervals with “consumables”, such as available game lines, instant prizes and vouchers available, from the host 1. These will be kept continually refreshed on demand if game lines held in the remote controller 3 are running low. Details of the lines and prizes issued as well as customer and transaction details are continuously transmitted back to the host 1 in small “batches” as required. Each operator station 4 consists of a combination of a ticket printer 7 and a point of sale 29 (POS) consisting of preferably a bar code reader and/or card reader, keypad and display 30. To save cost and counter space, some operator station functionality may be provided by sharing components of standard POS equipment used for normal transaction capture and processing.

Display devices 6 will also be supported by the host or remote controllers. Display devices 6 will display current game prize levels and other promotional material supplied by the host from time to time.

Referring to FIG. 2, the remote controller 3 is connected to enabled merchant outlet POS stations 29, corporate merchant billing files or Internet merchant web servers and receives full details of each transaction completed. This data is analysed to arrive at the number of game lines, if any, instant prize or voucher, that the customer concerned qualifies for. In POS situations if appropriate a qualification message may be sent to the relevant operator station display 30 prompting the operator to ask the customer if they wish to receive a ticket. The response is indicated to the remote controller via a keypad at the point of sale or operator station. This customer acquiescence step may be asked directly for Internet customers or indicated via an appropriate flag on customer records for corporate merchants. Yes responses cause a ticket to be printed, instant prize awarded or voucher printed. Details of tickets printed, game lines allocated and instant prizes and vouchers awarded, along with customer transaction details are sent to the host immediately or at regular intervals, as dictated by a system program, for game control, customer relationship management, accounting and prize pool update purposes.

As well as a ticket printer 7, unless this functionality is provided by shared use of standard POS componentry, the operator station 4 comprises preferably a programmable hand held keypad or display that can control communications with the local controller 3 and drive a barcode reader and the ticket printer 7 locally. When printed, game ticket content also includes a unique identifying barcode. This barcode contains details of game lines so that winning tickets can be scanned by the barcode reader and minor prizes awarded at the operator station 4. Provision will also be included in the system for tickets to be stored and claimed electronically including via various types of plastic cards.

These cards may be in the form of a loyalty card. This card will retain customer information and record their ticket numbers for them. Additionally when the card is swiped a message will automatically appear on the operator station or viewing station that advises of any wins on any game lines as well as other promotions based on buying patterns. Here the loyalty cards are scanned and the details captured directly by the host system 1. PINS will be used for customer ID if the customer has not made a qualifying purchase, the transaction is aborted. Loyalty cards will need to be processed at the host system 1, cards can be used anywhere and all transaction details are recorded against the cardholders for later analysis. Bonus awards are allocated to the existing purchase ticket entitlement.

Furthermore, the host system 1 has the ability to add a customer identifier to a purchase transaction, game lines and other rewards wherein the customer may be identified by way of loyalty cards, etc. Also, when a customer uses a personal credit card, barcode, loyalty card or other device that identifies them at the time of making a purchase, the host system captures this identifier and attaches it to the related transaction.

The promotional methodology of the present invention is implemented by software loaded into the host operations server 1 and remote controllers 3. A description of the functions preformed by the software now follows.

Referring to FIG. 2, entry module 15 allows the promotion facilitator to define ‘spend criteria’ promotions. Spend criteria promotions may be related to the total montary value of all purchases in a transaction or may exclude one or more products or entries from the calculation. The promotion is entered into the host 1 and downloaded into the remote controllers 3 at each of the relevant merchant outlets. When a sale is made at the merchant outlet software module 8 has a validation process which will examine the transaction record and determine if any of the spend criteria promotions apply, and then allocate the required lines to the ticket.

Entry module 16 allows the promotion facilitator to define system recognised “promotions”. A promotion may be related in any combination to a product, a group of products, a group of merchants, a single merchant or a specific customer. Promotions also have normal controls such as a beginning and end date for their validity. The promotion is entered into the host 1 and down loaded into the remote controllers 3 at each of the relevant merchant outlets. When a sale is made at the merchant outlet, software module 9 has a validation process which examines the transaction record and determines if any of the promotions apply, and then allocates any number of required lines to the ticket.

Software module 10 defines a number of instant prize entities which are entered into the host operations server by the promotions facilitator via entry module 17. The criterion upon which the instant prize is to be awarded is also set via entry module 17 and prize entries may have a criteria that allow for the instant prize to be specifically set aside for a specific merchant outlet Module 10 generates prize vouchers based on any criterion that is entered by the promotions facilitator. A merchant outlet's local controller 3 receives from the host 1, as required, the instant prizes for that outlet. Then the local controller will allocate the instant prize when there is a match with the prize criteria.

Software module 18 validates an instant prize voucher and marks that instant prize entity as redeemed. Redemption is broken into two processes, one for each of minor and major prizes. Minor prizes are redeemed at merchant level using appropriate control procedures, with redemption records being sent to the host 1 for reconciliation. Major prizes are redeemed by winners sending their prize vouchers to the promotions facilitator for processing. Minor prize redemption is done online to the remote controller 3 system to ensure as far as possible that there can be no fraud. The host system allows the promotions facilitator to validate vouchers that are over the merchant outlet limit, and have been sent to the promotions facilitator for redemption. The prize records are marked as having been redeemed once approved to ensure pay out does not happen twice.

Entry module 19 allows the promotion facilitator to define an associated product voucher offer. This is a voucher that is printed at the operator station 4 by the merchant outlet if a specific type of product has been purchased or spending criteria have been met (such as, the purchase of a number of items) during a transaction. The “associated product voucher” offer is entered into the host 1 (entry module 19) and the merchant outlet's remote controller 3 down loads the associated product voucher offers via software module 11. Again, a validation process will then examine the transaction record and determine if any of the associated product vouchers apply. A customer may use this voucher immediately or when they next choose to purchase at a member merchant outlet. When valid associated product vouchers are presented, its barcode is scanned and compared to the customers purchases, the remote controller 3 will check the POS record received for the customer concerned and if the associated product voucher item has been purchased, will print the game lines earned on the customer's ticket.

Entry module 20 allows the promotion facilitator to define “voucher promotions”. These are promotions that are triggered by pre-printed vouchers that are distributed via several mechanisms, including newspaper inserts, store displays, kiosks, the Internet and other devices. Vouchers, when presented in conjunction with purchase of the associated product, prompt award of game lines. Voucher promotions are loaded by the promotion facilitator into the host 1 via entry module 20, then details of these are down loaded to a merchant outlet's remote controller 3 via software module 12. When valid vouchers are presented, the barcode is scanned and the local controller 3 checks the POS record received for the customer concerned and if the associated voucher promotion item has been purchased, will print the game lines earned on the customer's ticket.

Vouchers may be printed from the Internet as previously mentioned. Here, a prospective customer, using a personal computer may go on-line and view various vouchers. The customer may download these vouchers and print the vouchers via a printer associated with their computer and use the vouchers in conjunction with the purchase of a product.

Software module 13 and 21 enables the promotions facilitator to record and analyse the POS transaction lines captured by the remote controller 3. These are stored in the remote controller 3, and are uploaded to the host operations server 1 immediately, or on a regular basis to be stored at the back-office system 2 in the data warehouse software module 27.

Software module 23 is the heart of the present invention and manages the generation and assignment of game lines to tickets. To ensure an even coverage of possible game lines, every possible ticket line will be generated by module 23 and then randomly stored at the host. A merchant outlet's remote controller 3 will then receive these randomized game lines in module 14 as required for award to qualifying customers. Once assigned to a ticket, these lines are regularly uploaded to the host 1 for lottery management and redemption purposes. Module 14 also interfaces with the merchant's system to retrieve the transaction lines for products purchased, customer information and the purchase total. Module 14 takes the information from many of the other modules and for each transaction processed, analyses the components of the transaction to determine if game line awards should be made. If there has been an eligible purchase, it allocates a ticket with game lines, awards any instant prize and generates any product vouchers applicable.

A further entry module 26 allows the promotions facilitator to enter in the lottery numbers that have been drawn for the periodic draw. Each ticket may be valid for one or more specific periods. Software module 24 compares each ticket line passed to it from module 23 with the currently entered drawn numbers to determine if it is a winning line. It will also produce statistics on how much money or other prizes have been won in each periodic lottery, advise the remote controllers of winning tickets and reset the game for the new period.

Software module 25 validates a winning game ticket and marks that game prize entity as redeemed. Redemption is broken into two processes, one for each of minor and major prizes. Minor prizes are redeemed at merchant level using appropriate control procedures, with redemption claims being sent to the host 1 for confirmation. Major prizes are redeemed by winners sending their prize vouchers to the promotions facilitator for processing. All redemption is done online to either the remote controller or the host 1 system to ensure as far as possible that there can be no fraud. The host system allows the promotions facilitator to validate tickets that are over the merchant outlet limit and have been sent to the promotions facilitator for redemption. The winning line entities are marked as having been redeemed once approved to ensure payout does not happen twice.

In the preferred form of the present system and referring to FIG. 1, a provision is made for merchant display devices 6. These display items such as winning game lines, cash prize totals, promotional messages and can be specific to a merchant. A store's remote controller 3 preferably down loads information from the host 1 for display in store. One line of information that may appear on a display device is the current winning pool total. The display of the total will be such that it regularly changes, based on periodic updates from the host 1. This information is then sent to the connected display device. Display devices 6 may be physical displays at POS outlets or electronic panels for electronic and Internet outlets.

Furthermore, the preferred form provides the interface to a touch tone phone system to allow a caller to enter the ticket serial number and to have their ticket checked for winning game lines. Also the preferred form provides interfaces to an Internet system to allow a user to enter the ticket serial number and to have their ticket checked for winning game lines.

The preferred form of the present system provides quick check points 5 that are customer accessed stations the preferably comprise a scanner, keypad, display and optional card reader where customers can quickly check whether their tickets have won a prize. Here the customer can enter their ticket into a scanning device or the like to check for winning game lines. These points are preferably located in merchant outlets and other busy foot traffic locations such as airports, malls and the like.

In another embodiment the present invention may be used by corporate merchants and in this application all the features of the method of sales promotion using POS systems are used except that transactions being analysed for award of game lines, instant prizes and vouchers are provided to the system via a remote controller communicating with a host system belonging to a corporate merchant.

Corporate merchants will use the system to promote sales based on details of transactions related to invoices generated for their customers. Transaction details will be fed to a remote controller associated with the corporate merchant from a billing file generated by the corporate merchant's host system. These transactions will be analysed in the same way as described for the POS based application described above, and awards made as appropriate depending on criteria set by the corporate merchant.

Awards may be printed on or to accompany invoices, or be advised to the corporate merchant's customers separately depending on logistics and the customer contact preference of the merchant. In other respects such as prize redemption and the like, the invention as applied to corporate merchants will be the same as described for POS merchants.

In a further embodiment the invention can be used by Internet merchants and in this application all the features of the method of sales promotion using POS systems are used except that transactions being analysed for award of game lines, instant prizes and vouchers are provided to the system via the Internet from a remote controller comprising a web server and communicating with a web server belonging to an Internet merchant.

Internet merchants will use the system to promote sales based on details of transactions including purchases made by customers via their Internet site. Transaction details will be fed to a remote controller comprising a web server associated with the Internet merchant as these transactions are being completed. These transactions will be analysed in the same way as described for the POS based application described above, and awards made as appropriate depending on criteria set by the Internet merchant.

Awards maybe advised over the Internet at the time of qualification, printed to accompany goods shipped, or be advised to the Internet merchant's customers separately including electronically depending on logistics and the customer contact preference of the merchant. In other respects such as prize redemption and the like, the invention as applied to Internet merchants will be the same as described for POS merchants.

The system will have the additional function of having a website available to the public and to merchants. There will be two levels of access wherein the public access is via a normal browser process and the merchant access is automated so that access can be gained via an appropriate icon on a PC screen or the like. The only customer input desired apart from the access icon is user ID and password. The merchant will, once entering the website have access to pages containing reports with regard to the client and system. Access to individual reports will only be allowable by entering IDs and passwords.

The system will have the additional function of allowing prizes to be won by matching game lines issued at point of sale or via the web with game lines on display instore or on the web. The method of redeeming the tickets that qualify for these prizes and awards is the same method as that already outlined for redemption.

We claim:

1. A method of sales promotion using sales systems, which record customer sales data, under the control of one or more merchants and a sales promotion computer system comprising the steps of:
(a) generating and storing random numbers at said sales promotion computer system;
(b) loading awards records on said promotion system consisting of sales criteria which defines customer award entitlement;
(c) comparing customer transaction data received from a sales system with said award records at said promotion computer system to determine if the customer is entitled to an award, and if so;
(d) printing on a document associated with each transaction one or more of said numbers;
(e) said printed numbers constituting a lottery ticket in a lottery to be drawn on a periodic basis with prizes awarded to ticket holders having a number or numbers which are the same as or are a defined sub-set of the numbers drawn.

2. A method of sales promotion according to claim 1 using sales systems which record customer sales through a website accessible from a web device operated by said customer and printing of said document is performed by a printer associated with said web device.

3. A method of sales promotional according to claim 1 using sales systems which record customer sales through a corporate merchant and wherein said customer is another business and said document is printed by said corporate merchant and included with transaction receipts.

4. A method of sales promotion using point of sale (POS) systems under the control of one or more merchants and a computer system controlled by a promotion facilitator consisting of a host and a plurality of remote controllers each associated with a respective POS system, said method comprising the steps of.
(a) generating and storing lines of random numbers at the host computer;
(b) transmitting said lines of numbers from said host to each remote controller;
(c) defining awards records at said host computer using merchant, customer, product, and purchase value data which will entitle customers to awards;
(d) transmitting said awards records from said host computer to appropriate remote controllers;
(e) receiving at each remote controller, customer, product and price data corresponding to the product purchases by each customer at the corresponding POS system.
(f) comparing said customer transaction data with said award records data at said remote controllers to determine if the customer is entitled to an award, and if so;
(g) printing a ticket at said POS system having one or more of said lines of numbers;
(h) said ticket being a lottery ticket in a lottery to be drawn on a periodic basis with prizes awarded to ticket holders having a line of numbers which are the same as or a defined sub-set of the numbers selected in the lottery draw.

5. A method of sales promotion according to claim 4 wherein said method further comprises the step of transmitting details of said ticket, said award, and said customer transaction data after printing of said ticket from said remote controller to said host computer.

6. A method of sales promotion according to claim 4 that includes the steps of:
(a) defining instant prize records at the host computer using merchant, customer, product and purchase value data which will entitle customers to an instant prize;
(b) transmitting said instant prize records from the host computer to appropriate remote controllers;
(c) receiving at each remote controller, customer, product and price data corresponding to the product purchases made by each customer at the corresponding POS;
(d) comparing said customer transaction data with said instant prize records data at each said remote controller to determine if the customer is entitled to an award, and if so;
(e) print a voucher at the ticket printer associated with the appropriate said POS system giving the customer the entitlement to a prize as described on the voucher.

7. A method of sales promotion according to claim 4 that includes the steps of:
(a) defining an associated product voucher;
(b) defining associated product voucher records at the host computer using merchant, customer, product and purchase value data which will entitle customers to an associated product voucher;
(c) transmitting said associated product voucher records from the host computer to appropriate remote controllers;
(d) receiving at each remote controller, customer, product and price data corresponding to the product purchases made by each customer at the corresponding POS;
(e) comparing said customer transaction data with said associated product voucher records data at each said remote controller to determine if the customer is entitled to a voucher, and if so;
(f) print a voucher, said POS system, giving the customer the entitlement to game lines as described on the voucher, when said voucher is used in conjunction with the purchase of the product named on said voucher.

8. A method of sales promotion according to claim 4 that includes the steps of:
(a) reading into an operator station data contained on a promotional voucher;
(b) receiving at each remote controller customer, product and price data corresponding to product purchases made and vouchers presented by each customer at a corresponding POS;
(c) comparing said customer transaction data with the said promotional voucher data at said remote controller to determine if a promotional product is included, and if so;
(d) printing a ticket said POS system having lines of numbers dependent on the value and/or the number of vouchers.

9. A method of sales promotion according to claim 8 wherein said promotional voucher has been printed by said customer when said customer uses a computer connected to a network, such as the Internet, to access a website and print, to a printer connected to said computer, said promotional voucher.

10. A method of sales promotion according to claim 4 that includes the steps of defining promotions records at the host computer using merchant, customer, product, and purchase data which will entitle customers to awards;
(a) transmitting said promotional records from the host computer to appropriate remote controllers;
(b) receiving at each remote controller, customer, product and price data corresponding to the product purchases made by each customer at the corresponding POS;
(c) comparing said customer transaction data with said promotions records data at said remote controllers to determine if the customer is entitled to an award, and if so printing a ticket at said POS system having lines of numbers dependent on the promotions record data.

11. A point of sale (POS) promotion system comprising remote controllers associated and communicating with POS systems under the control of one or more merchants and a host computer controlled by a promotion facilitator, said remote controllers having ticket printers associated therewith, said controllers and computer programmed to:
(a) generate and store lines of random numbers at the host computer;
(b) transmit said lines of numbers from said host to each remote controller;
(c) define awards records at said host computer using merchant, customer, product, and purchase value data which will entitle customers to awards;
(d) transmit said awards records from said host computer to appropriate remote controllers;
(e) receive at each remote controller product, customer, and price data corresponding to the product purchases made by each customer at the associated POS system;
(f) compare said customer transaction data and said award records data to determine if the customer is entitled to an award, and if so;
(g) print at the ticket printer of the appropriate POS system, a ticker having one or more of said lines of numbers;
(h) said ticket being a lottery ticket in a lottery to be drawn on a periodic basis with prizes awarded to ticket holders having a line of numbers which are the same as or a defined sub-set of the numbers selected in the lottery draw.

12. A method of sales promotion according to claim 11 wherein step (f) comprises manually determining whether said customer is entitled to an award.

13. A point of sale (POS) promotional system according to claim 11 wherein each said POS computer processor includes a bar code reader.

14. A point of sale (POS) promotion system according to claim 11 wherein said remote controllers includes display devices, which display promotional material including winning game lines and cash prize totals of said lottery draw periodically.

15. A point of sale (POS) promotion system according to claim 11 wherein said host computer includes a touch tone phone system interface which allows a caller to enter said tickets identification number, means for checking for a match between said ticket and said winning game lines and means for outputting an appropriate voice response to said interface dependent upon whether a match is found or not.

16. A point of sale (POS) promotion system according to claim 11 wherein said host computer includes interfacing to an Internet system which allows a user to enter said tickets identification number, means for checking for a match between said ticket and said winning game lines and means for outputting an appropriate visual response on said Internet system interface dependant upon whether a match is found or not.

17. A point of sale (POS) promotion system according to claim 11 wherein said host system includes stand alone check points comprising a scanner, keypad and display, which allows a customer holding an eligible game ticket to scan said ticket, means for checking for a match between said ticket and said winning game lines and means for outputting an appropriate visual response on said check point display interface dependent upon whether a match is found or not.

18. A point of sale (POS) promotion system according to claim 17 wherein said standalone checkpoints further comprise a card reader.

19. A point of sale (POS) promotion system according to claim 11 wherein said promotion system includes a website allowing said customer to enter a customer identification number and be given access to individual customer game lines, customer specific promotional offers, winning lines and prize details.

20. A point of sale (POS) promotional system according to claim 11 wherein said promotional system includes a website allowing said merchant to enter a merchant identification number and be given access to reports comprising sales transaction data which is printable.

21. A point of sale (POS) promotional system according to claim 11 wherein said host system includes a means for issuing plastic cards, storage means to allow for game lines to be stored on said card, card reading means at said remote controllers, means for checking for a match between said ticket and said winning game lines and means for outputting an appropriate visual response at said remote controller dependent upon whether a match is found or not.

22. A point of sale (POS) promotional system according to claim 11 wherein said host system includes a customer identifier for a purchase transaction, game lines and other rewards, wherein said customer may be identified when a customer users a personal credit card, barcode, loyalty card or other device that identifies them at the time of making said purchase.

23. A point of sale (POS) promotional system according to claim 11 wherein said host system captures said identifier and attaches it to said related purchase transaction.

24. A method of sales promotion using sales systems under the control of one or more merchants and a sales promotion system comprising the steps of:
(a) receiving from said sales promotion system lines of numbers at a remote controller.
(b) receiving award records from said sales promotion system to said remote controller.
(c) receiving at each remote controller, customer, product and price data corresponding to the product purchases by each customer at the corresponding POS system of said remote controller,
(d) comparing said customer purchase data with said award records data at said remote controllers to determine if the customer is entitled to said award, and if so;
(e) printing on a document associated with each transaction one or more of said numbers and/or voucher and/or instant prize entitlement;
(f) said printed numbers constituting a lottery ticket in a lottery to be drawn on a periodic basis with prizes awarded to ticket holders having a number or numbers which are the same as or are a defined subset of the numbers drawn.

25. A method of sales promotion using sales system under the control of one or more merchants and a sales promotion system comprising the steps of:
(a) generating and storing lines of numbers at the host computer;
(b) transmitting said lines of numbers from said host to said merchant,
(c) defining awards records at said host computer using merchant, customer, product and purchase value data which will entitle customers to awards,
(d) transmitting said awards from the host computer to said one or more merchants, said one or more merchants being able to print on a document one or more said numbers, said document being given to said customer when said customer's purchases correspond to said awards records, said document constituting a lottery ticket and/or voucher and/or instant prize entitlement.
